(19) United States
(12) Patent Application Publication
(10) Pub. No.: US 2005/0050146 A1
(43) Pub. Date: Mar. 3, 2005

(54) Mail management system and method

(76) Inventors: Ali Jani, Fairfax, VA (US); Nayan Vadher, Gainesville, VA (US)

Correspondence Address: DLA PIPER RUDNICK GRAY CARY USA, LLP, 2000 UNIVERSITY AVENUE, E. PALO ALTO, CA, 94303-2248, US

(21) Appl. No.: 10/847,776

(22) Filed: May 17, 2004

Related U.S. Application Data
(60) Provisional application No. 60/498,911, filed on Aug. 29, 2003.

(51) Int. Cl. G06F 15/16

(52) U.S. Cl. 709/206

(57) ABSTRACT

A mail management method and system are described that tracks correspondence exchanged with external entities such as customers and vendors, through e-mail messages, and the internal users of the system. The e-mail messages are then desirably imported into business software (of various types) and linkages created to such external entities within business software, from the E-mail Clients. In more detail, correspondence in the form of e-mail is automatically imported into business software and Tasks created in accordance with the invention. In the process, a repository of external e-mail correspondence is maintained within the business software. The mail management system in accordance with the invention is efficient, cost-effective and accurate, that would otherwise not be possible manually.

### PRIORITY CLAIM

This application claims priority under 35 USC 119(e) to U.S. Provisional Patent Application Ser. No. 60/498,911, filed on Aug. 29, 2003 and entitled “Mail Management System and Method” which is incorporated herein by reference.

### FIELD OF THE INVENTION

The present invention relates generally to a e-mail management system, and more particularly, to a method and apparatus for linking e-mail messages received from/sent to Business Partners of an organization via an E-mail Client to Everest Advanced Edition (“Everest”) client.

### BACKGROUND OF THE INVENTION

E-mail correspondence has become an integral part of modern business operations. The increased effort to use the electronic mailing in business is due to the fact that electronic mailing is extremely cost effective and less time consuming. In particular, an electronic message does not require any postage and can be generated from any computing device with an E-mail Client. Furthermore, the physical delivery by regular postal mail (“snail mail”) takes time whereas e-mail can be delivered instantaneously.

It is desirable to maintain a linkage between external e-mail correspondence and related entities within business software applications. In particular, it is desirable to be able to accurately capture and track business e-mail correspondence and then generate Tasks and the like based on the e-mail correspondence. However, despite the fact that e-mail is being used extensively in modern business, there has been no method or system by which these e-mails can be automatically stored in a business software application and have Tasks and other actions generated from these e-mail messages. Typically, one must resort to printing of the messages or generating manual markings or reminders in the business software applications. This typical processes are slow, tedious and inefficient.

There are currently two Internet standards for the submission and receipt of e-mail messages between a client and a post office (electronic mail server/system). The first one is “Post Office Protocol Version 3” known as ‘POP3’ and the second one is “Internet Message Access Protocol” known as ‘IMAP’. If one uses a “POP3” Post Office/Server, then it is necessary for the client to download the e-mails in a local directory whereas if a client uses an “IMAP” Post Office/Server, he/she need not download the message into a local directory. The IMAP protocol, although space saving in terms of computer hard disk since the messages are not downloaded to a local directory, creates the possibility for mistakes in not keeping proper track of the incoming/outgoing e-mails and actions connected therewith since there is not a local copy of the messages. In both systems, it is not possible to download a message and link it with existing business software applications. There also exists a third known e-mail message protocol, “Messaging Application Programming Interface” (“MAPI”), which is exclusively used by Microsoft. The MAPI protocol is very much like IMAP, but provides extended features within Microsoft Outlook, which is an Microsoft's E-mail Client software. Other popular E-mail Client software includes Entourage (IMAP, POP3), Mac Mail (IMAP, POP3), Eudora (POP3), Outlook Web Access (Hypertext Transfer Protocol i.e. HTTP), Outlook (MAPI, IMAP, POP3) and Outlook Express (POP3, IMAP).

The proposed e-mail management system of the present invention ensures reduced manual labor with the greatest possible linkage of various bodies of related data. Thus, it is desirable to provide a mail management system and method that overcomes these limitations of typical systems and it is to this end that the present invention is directed.

### SUMMARY OF THE INVENTION

A mail management method and system are described that tracks correspondence exchanged with external entities such as customers and vendors, through e-mail messages, and the internal users of the system. An example of the implementation of the mail management system of the present invention is the “MailBridge” module associated with the Everest business software application that was developed by iCode, Inc. The e-mail messages are then desirably imported into business software (of various types) and linkages created to such external entities within business software, from the E-mail Clients. In more detail, correspondence in the form of e-mail is automatically imported into business software and Tasks created in accordance with the invention. In the process, a repository of external e-mail correspondence is maintained within the business software. The mail management system in accordance with the invention is efficient, cost-effective and accurate, and the mail management in accordance with the invention would otherwise not be possible to achieve manually.

In accordance with the invention, there is provided a mail management method and apparatus for retrieving, adding and linking e-mail correspondence sent to/received from Business Partners to a business software application in the form of Tasks or e-mails. This will ensure proper tracking of outstanding issues in a timely and efficient as well as cost-effective manner.

The mail management system and method in accordance with the invention provides various advantages over the typical systems. In a preferred embodiment, the mail management system and method is part of the Everest software application developed by iCode, Inc. which is the owner of this patent application. Thus, the mail management system and method permits the importation of external correspondence between Everest e-mail users and their Business Partners in the form of e-mail messages, into other business software application. The mail management system and method also associates such e-mail messages with relevant Business Partners in the business software application. The system further permits indexing and warehousing of such e-mail messages and related data and attachments for data mining and tracking purposes and enhanced customer relationship management. The system further ensures that no correspondence with Business Partners goes unrecorded/untracked by creating Tasks for the relevant Business Partners concerned, leading to a positive impact on business growth. The system also provides the ability to view the e-mail messages and attachments for a Task or Business Partner by various parameters imported from the external E-mail Client. The system further generates a back-up of all the messages that are imported into the business software application.

Thus, in accordance with the invention, a mail management method for retrieving and adding the incoming/outgoing e-mail messages to an existing database is provided. In the method, each message is scanned for the contents of the message headers, including but not limited to the TO, CC, BCC and/or FROM fields of an e-mail message, and the e-mail addresses in these fields are compared to all the e-mail addresses contained in an associated business software application database. When a match between the address in the message and the business software application database is found, the e-mail message and its attachments (if any) are added into the database. If a match is not found for the current message, any new e-mail addresses are added into the database along with the contents of the e-mail message. A Task may be created, wherever necessary along with necessary links to the database or create necessary links for tracking purposes.

In accordance with another aspect of the invention, a mail management method for retrieving and adding the incoming/outgoing e-mail messages to an existing data base is provided. In the method, each message is scanned for the contents of the message headers, including but not limited to the TO, CC, BCC and/or FROM fields of the e-mail message, and the e-mail addresses in these fields are compared to all the e-mail addresses contained in an associated business software application database. When a match between the address in the message and the business software application database is found, the e-mail message and its attachments (if any) are added into the database. If a match is not found for the current message, any new e-mail addresses are added into the database along with the contents of the e-mail message. A Task may be created, wherever necessary, along with necessary links to the database for tracking purposes. In this method, the user is permitted to select the messages to be imported to the database and the user can specify the e-mail addresses or address patterns that are not to be imported into the database.

In accordance with yet another aspect of the invention, a method and apparatus for importing external correspondence between Everest users and their Business Partners in the form of e-mail messages, into business software application is provided. The method and apparatus associate such e-mail messages with relevant Business Partners in the business software application. The apparatus and method also indexes and warehouses such e-mail messages and related data and attachments for data mining and tracking purposes and enhanced customer relationship management. The apparatus ensures that no correspondence with Business Partners goes unrecorded/untracked by creating Tasks for the relevant Business Partners concerned, leading to a positive impact on business growth. The apparatus also provides the ability to view the e-mail messages and attachments for a Task or Business Partner by various parameters imported from the external E-mail Client.

### BRIEF DESCRIPTION OF THE DRAWINGS

These and other aspects of the invention will become apparent from the following description read in conjunction with the accompanying drawings.

FIG. 1 is a diagram illustrating a system that includes the mail management system in accordance with the invention;

FIG. 2 illustrates the sequence of steps involved in setting up the e-mail management system;

FIG. 3A illustrates the sequence of steps involved in running the e-mail management system;

FIG. 3B illustrates an example of the computer implemented mail management system in accordance with the invention;

FIG. 4 portrays an example of the Everest server configuration interface;

FIG. 5 portrays an example of the e-mail server configuration interface;

FIG. 6 portrays the preference settings configuration interface;

FIG. 7 portrays the interface for running the e-mail management system in accordance with the invention;

FIG. 8 depicts the user interface in Everest for filtering Tasks by a user;

FIG. 9 depicts the user interface in Everest for filtering Tasks by document/customer/vendor;

FIG. 10 depicts the relationship between Tasks, e-mails created based on the import of e-mails and their relationship with other entities such as user and documents;

FIG. 11 is a diagram illustrating a Task browser application with an e-mail system task in accordance with the invention highlighted; and

FIG. 12 is an example of a user interface for a setting of the e-mail exclusion property of the e-mail message management system.

### DETAILED DESCRIPTION OF A PREFERRED EMBODIMENT

The invention is particularly applicable to an e-mail message management system and method, such as that included in the Everest system and it is in this context that the invention will be described. It will be appreciated, however, that the mail management system and method in accordance with the invention has greater utility, such as to various other electronic systems in which it is desirable to capture e-mail messages and associate them with a business software application.

For purposes of the following description, certain terms will be defined herein:

Everest: refers to Everest Advanced Edition, a business software application developed by iCode, Inc., which is used as an example to demonstrate the method in which this e-mail management system may be used in conjunction with a business software application.

Business Partner: Customers, vendors and other parties with whom the company has or shall have any relationship in the conduct of its business operations.

Workflow: The sequence of steps involved in or necessary for the achievement or fulfillment of a Task.

E-mail Client: An application, which acts as, the interface for receiving e-mail messages from or sending e-mail messages to Business Partners.

MAPI Compliant: A messaging application that complies with e-mail messaging standards.

Task: An entry created within the contact management module for follow-up by users of the business software applications.

A business software application that may incorporate the mail management system and method in accordance with the invention is described as follows. For this example, the Everest business software application developed by iCode, Inc. is used as an example to demonstrate the method in which this e-mail management system may be used in conjunction with a business software application although the present invention is not limited to any particular business software application.

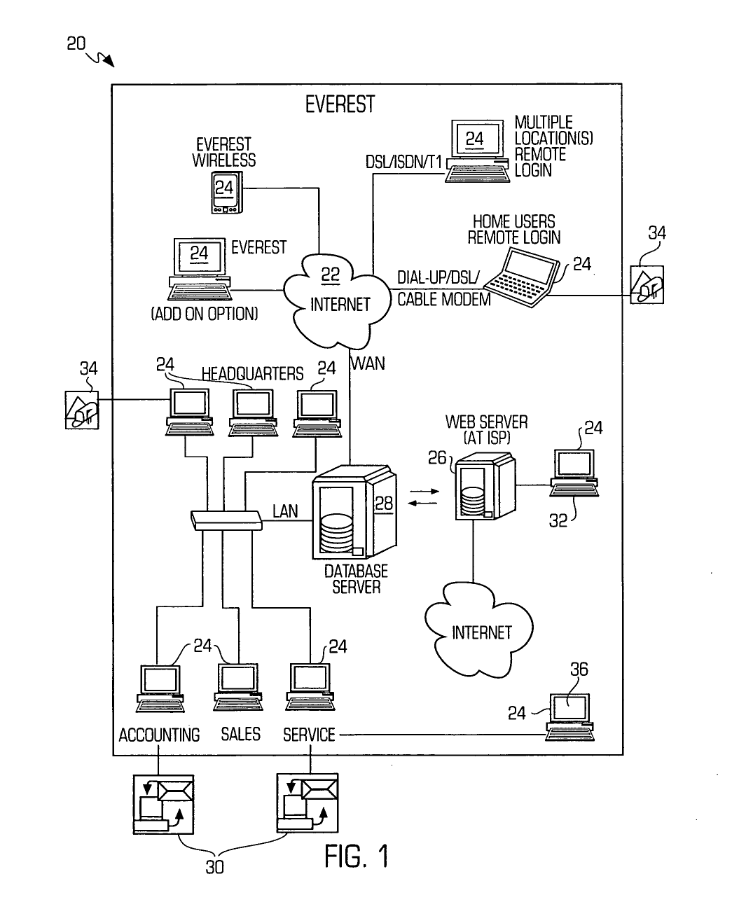

FIG. 1 is an overall block diagram of a business software application system 20 that incorporates a mail management system in accordance with the invention. In the preferred embodiment, the system 20 is the iCode, Inc. Everest software application that is being executed on a computer network/system as shown. However, the system may also be any other business software application. The system 20 is connected together by a computer network 22, such as the Internet as shown, the World Wide Web (“Web”) or any other computer network, wherein a plurality of different computing resources 24 are connected together. Each computing resource 24 is a computer system that is capable of executing computer software code to implement the business software application and the mail management system, such as the laptop, wireless device, and desktop systems as shown. Each computing resource has the well known components of a computer system, such as one or more processors, memory, such as SRAM or DRAM or flash memory, a persistent storage device, such as a hard disk drive, optical disk drive, or tape drive, and optional input/output devices, such as keyboards, mice, LCDs, CRTs, printers and the like. The system is not limited to any particular type of computing resource, however as the business software application may be implemented using various computer systems. The computing resources of the system 20 are connected together by a wide area network (WAN) and a local area network (LAN) as shown. As shown, the system 20 also may include a Web server 26 that permits Web access to the system by the computer resources 24. The system 20 may further include a database server 28 which is connected to the various computing resources and acts as a data repository for the system and its parts. The elements of the database server 28 are well known and not described herein. In a preferred embodiment, a Microsoft® SQL server may be used, but the database server may also be implemented using products developed by Oracle, Siebel and other software companies.

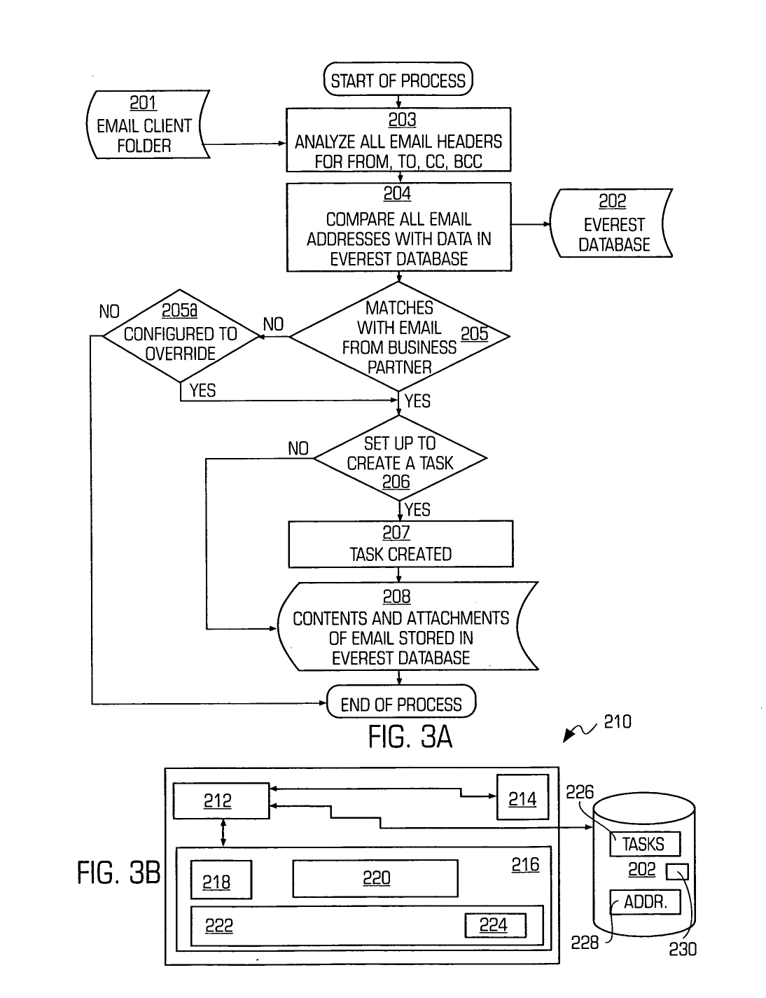

The system may further include a mail management system 30 that is integrated within Microsoft Outlook E-mail Client. The mail management system allows employees to be more informed on all e-mail interactions between customers and anyone in an organization and provides users With access to all such e-mails stored within Everest. In a preferred embodiment, the mail management system is one or more pieces of software code, executing on a computing resource 24, that perform the various functions of the mail management system as shown in more detail in FIG. 3B. The mail management system is described below in more detail. The system may further include a PageBoost system 32 that is a search engine solution, which integrates with Everest by generating optimized hypertext mark-up language (HTML) pages ready to be submitted to various search engines for higher page ranking, traffic hits and seamlessly integrates with Everest E-Commerce solution. In a preferred embodiment, the PageBoost system is one or more pieces of software code, executing on a computing resource 24, that perform various functions. The system may further include an E-mail Client system 34 that sends and receives e-mail directly from Everest. Employees are more informed because they have access to all e-mail sent between customers, vendors and anyone in an organization, wherein the Everest E-mail Client replaces any E-mail Client such as Outlook and integrates with Everest. In a preferred embodiment, the E-mail Client system is one or more pieces of software code, executing on a computing resource 24, that perform various functions. The system may further include a Pay Bridge system 36 that bridges between different payment processors for processing credit card transactions with different payment processors and integrates with Everest allowing customers to use their own payment processors. In a preferred embodiment, the Pay Bridge system is one or more pieces of software code, executing on a computing resource 24, that perform various functions. The mail management process and system is described as follows. First, the installation process for the mail management system is described.

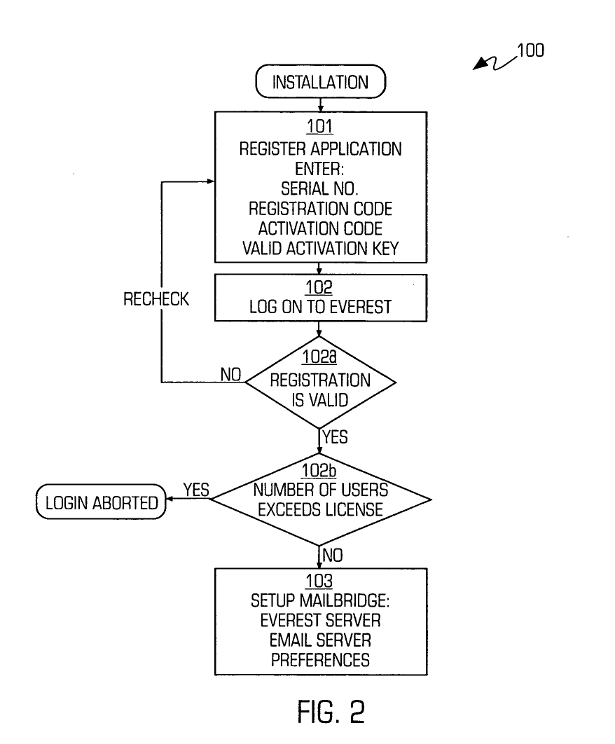

FIG. 2 portrays an installation procedure 100 for the mail management process in accordance with the invention. Initially, the e-mail and mail management client/software is installed onto a particular computing resource. Next, in step 101, the mail management software/process is registered by the user in the business software application, Everest in this example, through entry of various product information for the mail management system, such as a serial number, a registration code, a validation code and/or an activation key. In step 102, the user logs in to the process client. In step 102a, the system determines if the registration of the user is valid and loops back to step 101 so that the user enters different registration information if the currently entered information is not valid. If the registration is valid, then the system determines if the number of users for the particular installation of the mail management system has exceeded the license in step 102b and aborts the login if the number of users is exceeded. If the number of users is not exceeded, then the user sets up the process in step 103 by configuring the following pieces: Everest server, an e-mail server and user preferences. The process for mail management in accordance with the invention will now be described.

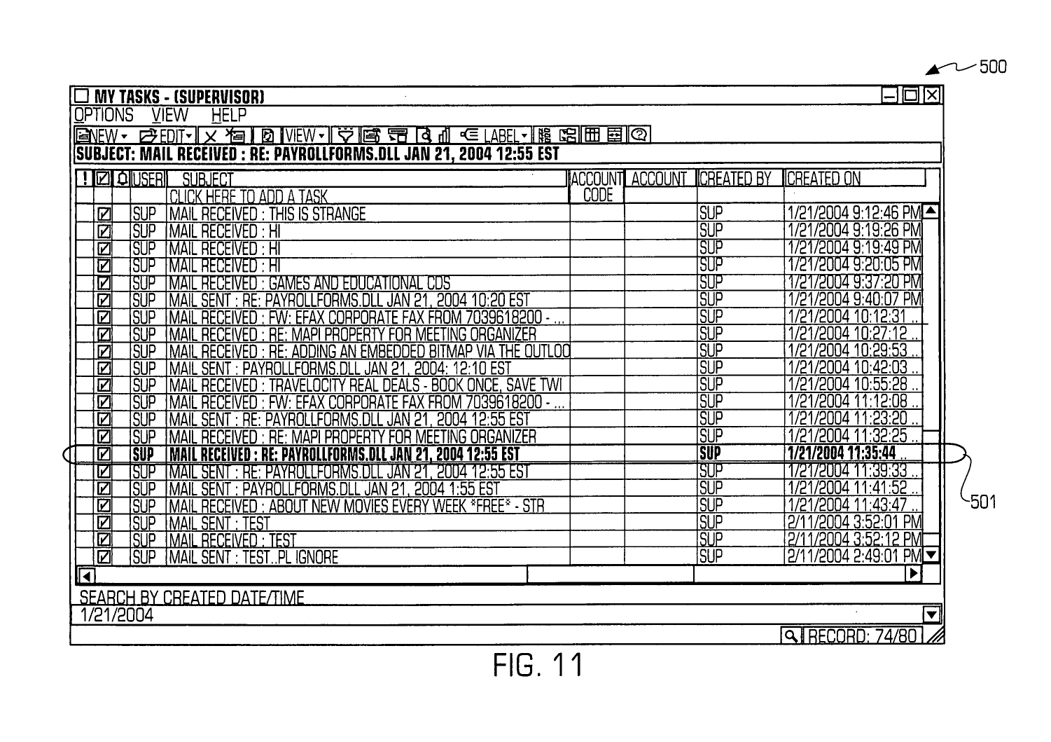

FIG. 3A portrays a typical system flow where the system 30 imports the e-mail messages into a business software application, such as Everest in a preferred embodiment. In steps 201 and 203, the system scans the e-mail messages (in a well known manner such as by reviewing the headers of the e-mails) in the e-mail inbox in the specified folder in an E-mail Client. For example, the mail management system may analyze all of the e-mail headers for contents in a FROM, TO, CC and/or BCC fields to identify the addresses and IDs of external organizations and users. In case of an incoming e-mail communication, all the incoming messages are scanned for the e-mail ID/address in the FROM field in the message headers. This e-mail ID is compared with all e-mail addresses of Business Partners stored in the business software application, such as Everest, database 202 in step 204 and 205. If a match is found, a Task or e-mail will be generated linking the sender's e-mail ID with the user currently logged into the business software application and the mail management system and apparatus. See steps 205-208. In particular, in step 205, if the e-mail address/ID matches an ID of a Business Partner in the database, then in step 206, the mail management system determines if it is set-up to create a Task. If the system is not set-up to generate a Task, then the contents of the e-mail and its attachments are stored in the database in step 208 and the process is completed. Returning to step 106, if the system is set-up to generate a Task, then the particular Task, which may be an actual Task, e-mail message or other action item, in generated in step 207 and the contents of the e-mail and its attachments are stored in the database in step 208 and the process is completed. In accordance with the invention, the particular Task/message generated for a particular e-mail message may be configured by the user. FIG. 11 shows a Task browser 500 that lists the various Tasks of a supervisor user. In accordance with the invention, the e-mail system in accordance with the invention generates its own Task, such as Task 501 shown highlighted in FIG. 11, based on an e-mail of the user. In this example, the user received an e-mail message and the mail system in accordance with the invention generated the Task.

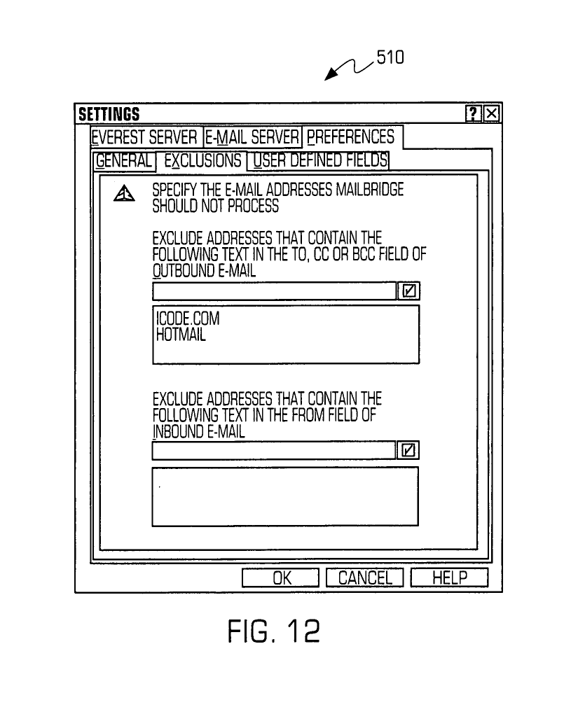

In case of an outgoing e-mail communication, the address/ID of the e-mail in the TO, CC and/or BCC fields will be compared with the e-mail ID's in the Everest Database 202 in step 204 as before. If a match is found (step 205), the system, if it is set-up to generate a Task (step 206), will generate a Task/e-mail linking each e-mail ID in the TO, CC, BCC fields with the user currently logged into the apparatus as above in step 207 and the e-mail and attachments are stored in the database in step 108. As above, if the system is not set-up to generate a Task, then the contents of the e-mail and its attachments are stored in the database in step 208 and the process is completed. For both incoming and outgoing messages, if no match is found, and the checkbox for creating the Task/e-mail even if no match is found is checked (i.e., the system is set-up to generate a Task and is configured to override no match), then the system will, in step 205A, add the new e-mail address if any, to the database 202 along with the contents thereof and also create the necessary links in step 207. In accordance with the invention, the user may optionally specify that any message headers not matched will also be imported. Thus, in step 205A, the user may optionally specify any e-mail addresses or address patterns that are not to be imported into the database 200. FIG. 12 illustrates an example of a user interface 510 that permits a user of the mail management system to specify that e-mail messages from/a particular domain, such as “icode.com” or “hotmail” as shown in FIG. 12 or from a particular e-mail address may be excluded from the e-mail messages that are being processed by the mail management system in accordance with the invention. As shown, the interface permits the user to exclude domains or e-mail addresses from both incoming and outbound e-mail messages. An example of the computer system implemented mail management system in accordance with the invention is described as follows:

FIG. 3B is a block diagram illustrating an example of a computer implement mail management system 210 in accordance with the invention. In accordance with the invention, the mail management system may also be implemented as one or more software modules/pieces with a plurality of instructions of code residing on a physical data storage medium, such as a CD, DVD or other storage medium, wherein the software is installed from the CD onto a computer system for execution or executed by the computer system directly from the physical data storage medium. Similarly, the mail management system may be implemented as pieces of software embedded onto a hardware device wherein a computer system executes the mail management system using the hardware device. The computer implemented system 210 comprises various well known computer resource components whose function and operation are not described as they are well known, including one or more processors 212, a persistent storage device 214, such as a hard disk drive, optical drive, tape drive or flash memory and a memory 216, such as DRAM, SRAM or the like, that stores the data and instructions being executed by the computer while the computer is turned on. The computer system 210 may further include other well known components such as various input/output devices and devices that connect the computer system to the Internet and a computer network.

To implement the mail management system in accordance with the invention, the computer implemented system includes the database 202 described above. The computer implemented system 210 further includes one or more pieces of software that implement the mail management system such as a well known operating system 218, a well known E-mail Client 220, a mail management application 222 with a user interface portion 224. In the example shown, these pieces of software reside in the memory 216 and are being executed by the processor 212 to implement the mail management system. For example, the E-mail Client is a typical E-mail Client that permits the user to view, create, send and receive e-mail messages and may be integrated into the mail management system in accordance with the invention. The user interface portion 224 may generate the user interfaces presented to the user during the execution of the mail management system. In accordance with the invention, the mail management system may generate one or more Tasks 226 that are stored in the database 226, may compare e-mail messages to addresses 228 stored in the database and store addresses into the database and may store the e-mail messages and attachments 230 into the database. Examples of the user interface to configure the system in accordance with the invention are described as follows.

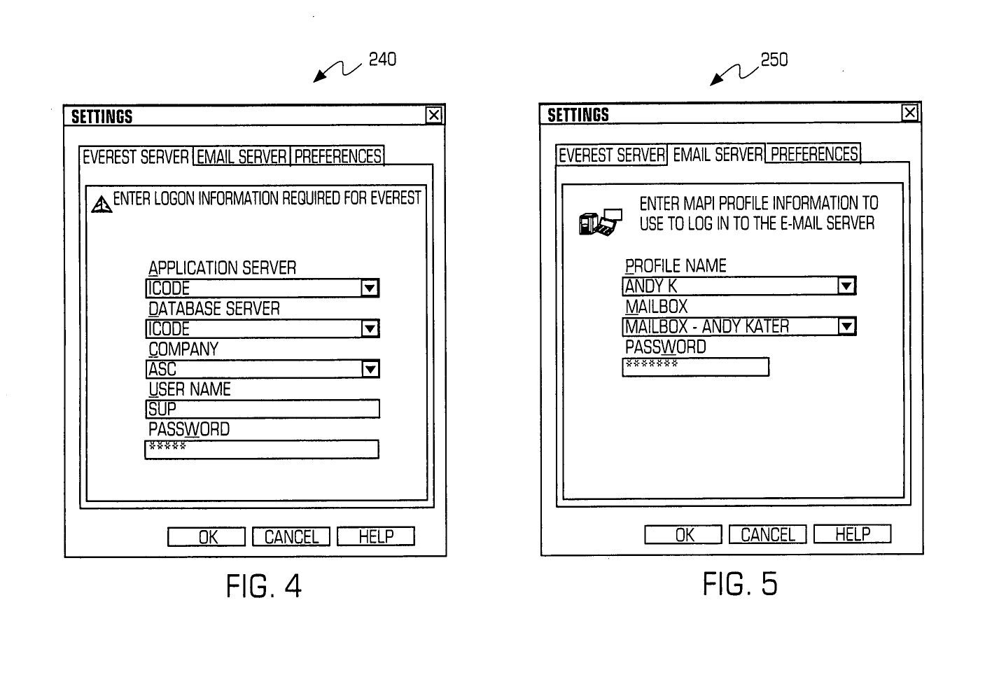

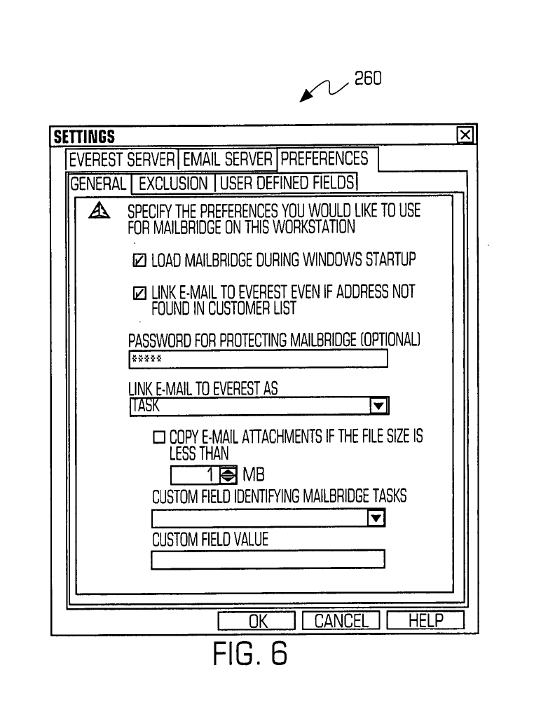

FIG. 4 illustrates a display screen 240 through which the user can set up the database server/Everest server. In particular, the display 240 permits the user to configure the mail management system and its association with the Everest server by entering information, such as the application server name, the database server name, the company name, the user name and password, so that the mail management system may interact with the business software application system and store data into the database server. FIG. 5 illustrates a display screen 250 for setting up of the e-mail server, such as by entering profile information, a mailbox identification and a password, which gives the mail management system access to the e-mail account of the particular user in order to import the e-mail messages into the business software application system. FIG. 6 is a display screen 260 for setting up the general preferences by the user when using the e-mail management system of the present invention. For example, the user may specify the methodology for linking as imported e-mail into the business software application, such as using a Task as shown, the user may specify a maximum e-mail attachment size for storage in the database and the user may specify a custom field that identifies a mail management system Task and specify its value. As shown, the user may also specify user-defined fields and exclusions using the user preference user interface. The mail management process and its user interface in accordance with the invention will be described in more detail as follows.

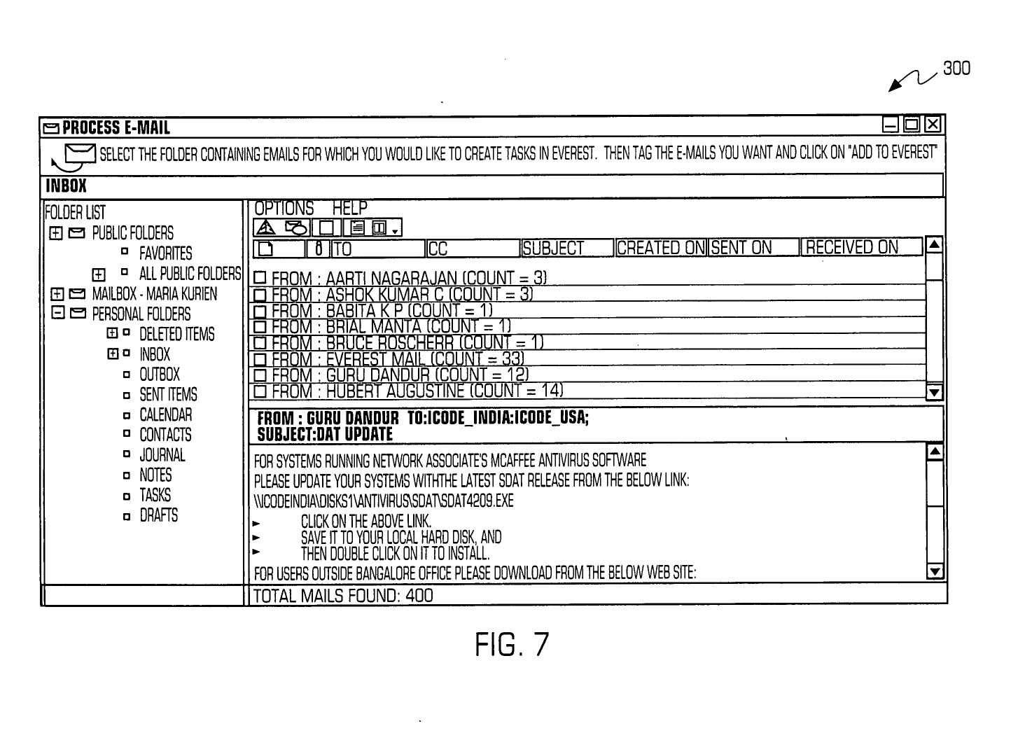

FIG. 7 displays mail management process and an example of a user interface 300 for the mail management system in which the user specifies the e-mail messages to be imported into the system. In particular, the process interface permits a user to set up and select the folders containing e-mails for which the user wants to create a Task so that the Tasks are added into the business software application system. For example, the system will permit an individual to specify that e-mails in a particular folder should generate a predetermined Task. As shown, the interface includes a first portion 302 that permits the user to navigate through his or her inbox (in this example an Outlook Inbox) while a second portion 304 permits the user to view any e-mail message or its attachment, to specify one or more folders to be imported and to specify particular e-mail messages (by tagging them) to add into the business software application system and database. Thus, this interface is a screen 300 that allows the user to import external e-mail prior to installation of the apparatus and view all Tasks/e-mails. In a preferred embodiment of the invention, all data can only be viewed in this interface and no e-mail messages can be sent from this screen. However, in an alternative embodiment, the mail management system may be integrated into an E-mail Client so that the interface may permit the sending and receipt of e-mail messages. In accordance with the invention, all e-mail communication, whether incoming or outgoing, will be treated the same way and a Task/e-mail will be created for each e-mail ID in the “FROM’, ‘TO’, ‘CC’ and ‘BCC’ fields. All e-mails/Tasks are stored in a single repository (the business software application database 202 in FIG. 3) for the entire company. Users with appropriate rights to view e-mails/Tasks for specific user may view the e-mails/Tasks for the user. Users with appropriate rights to view all e-mail/Tasks for all users may view the e-mail/Tasks for all users so that the mail management system may include a security portion that establishes the privileges of each user of the system.

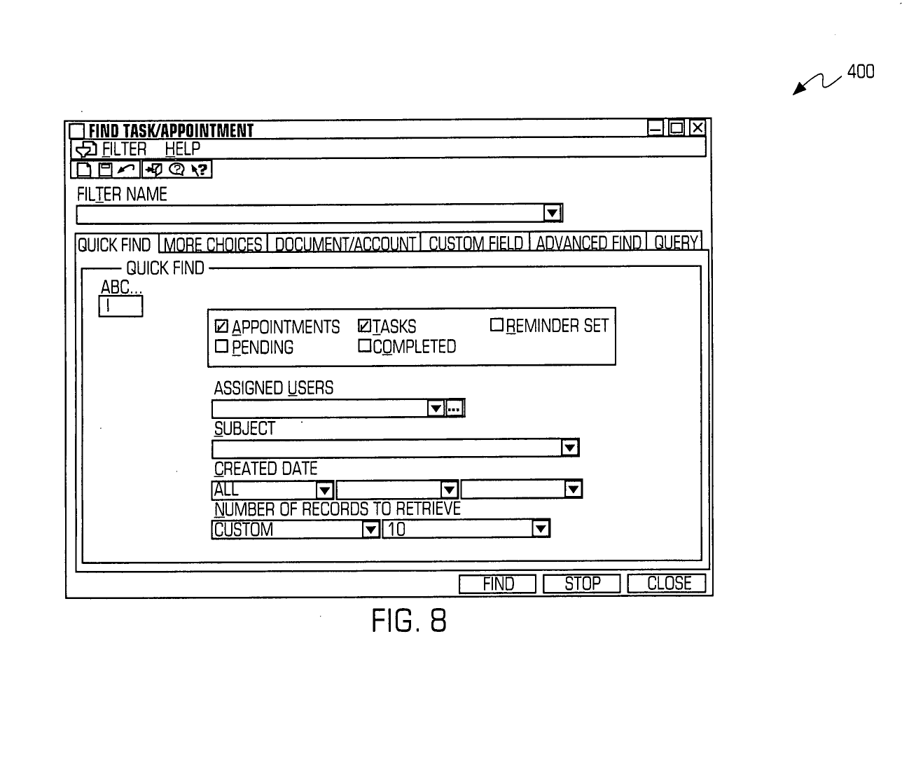

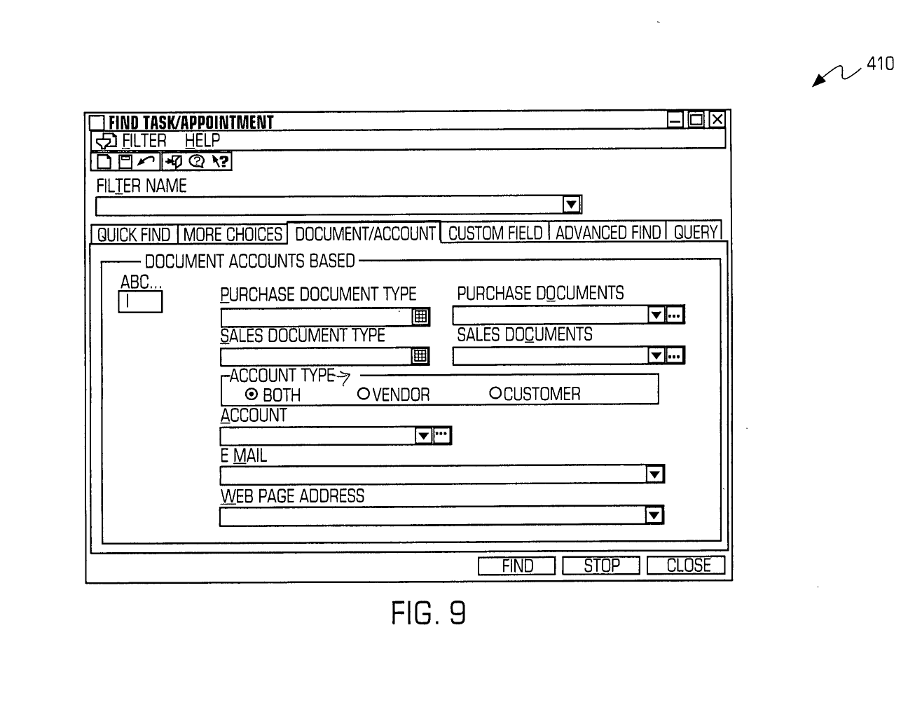

FIG. 8 illustrates a user interface 400 in which the user is able to find Tasks/appointments for a particular user. In particular, once the mail management system has generated Tasks/e-mail messages from the imported messages, the user may search for particular users, message subjects, creation date(s) or type of Task/message and message/Task status. Furthermore, the user may specify the number of records retrieved based on the search. Thus, the system provides the ability to view the e-mail messages and attachments for a Task or Business Partner by various parameters imported from the external E-mail Client. This is done through the “find filters” interface 400 where a Task/appointment may be searched for a customer/document or vendor/document combination. FIG. 9 illustrates a user interface 410 in which a Task/appointment, such as a follow up meeting, may be searched for by other parameters, such as a customer/document or vendor/document combination as shown.

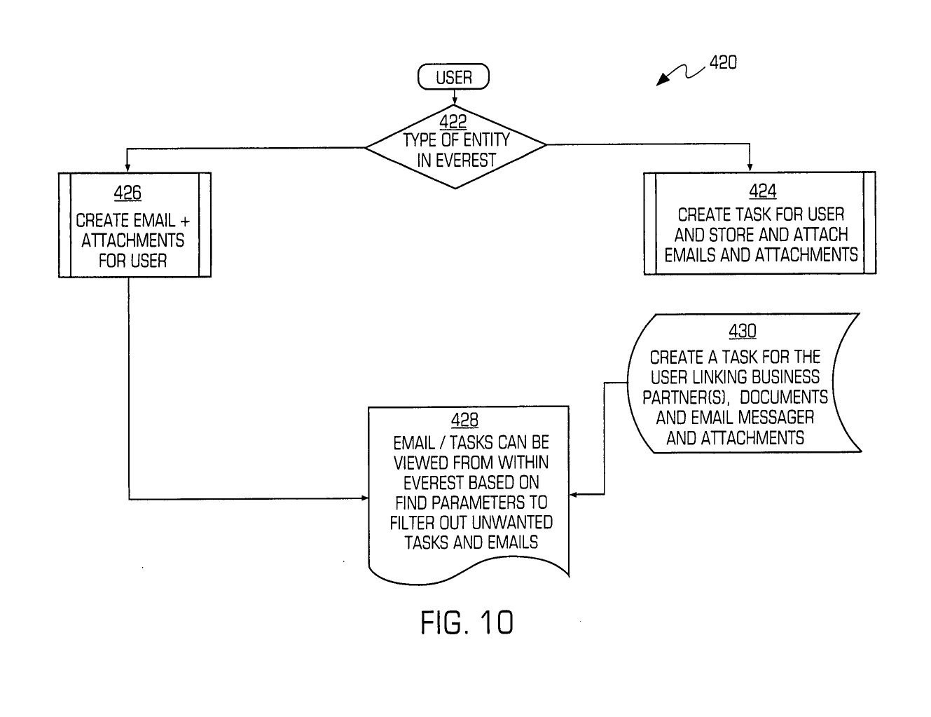

FIG. 10 depicts a chart 420 with the relationship between Tasks, e-mails created based on the import of e-mails and their relationship with other entities such as user and documents. In particular, an e-mail from a party is sorted in step 422 based on the type of entity in the business software application system. For example, the mail management system may create a Task for the user in step 424 and store the e-mail message and attachment(s) into the database. In the alternative, in step 426, the mail management system generates an e-mail with attachments for the user, then, the e-mail/Tasks with attachments may be viewed from within the business software application using the find interface described above based on “find” parameters to filter out unwanted Tasks and e-mails. In step 430, the mail management system creates a Task for the user that links the Business Partner(s) (the party identified in the imported e-mail message), and any documents and e-mail mail messages and attachments.

To summarize, the mail management system (known as MailBridge) may import e-mail messages from any MAPI Compliant E-mail Client into Everest and create messages, such as Tasks or e-mail messages, if the FROM, TO, CC and BCC fields contain any address that matches any e-mail address of customers/vendors in Everest. The mail management system may be easily implemented in any software solution as shown in FIG. 3B above.

The mail management system in accordance with the invention provides many advantages. The system provides for importing external correspondence between Everest users and their Business Partners in the form of e-mail messages, into business software application. The system also associates such e-mail messages with relevant Business Partners in the business software application. The system also indexes and warehouses such e-mail messages and related data and attachments for data mining and tracking purposes and enhanced customer relationship management. The system also ensures that no correspondence with Business Partners goes unrecorded/untracked by creating Tasks for the relevant Business Partners concerned, leading to a positive impact on business growth. The system also provides the ability to view the e-mail messages and attachments for a Task or Business Partner by various parameters imported from the external E-mail Client. This is done through the “find filters” interface where a Task/appointment may be searched for a customer/document or vendor/document combination. The system also makes a back up of all the messages and attachments that are imported.

While the foregoing has been with reference to a particular embodiment of the invention, changes in this embodiment may be made without departing from the principles and spirit of the invention, the scope of which is defined by the attached claims.

1. A mail management method for retrieving and adding e-mail messages to an existing business software application database, comprising:
scanning a header portion of each message to locate an identification;
comparing the identification with a plurality of identifications stored in a business software application database to identify a matching identification;
adding the message with the matching identification into the business software application database wherein the message is associated with the matching identification; and
creating a Task associated with the message that is linked to the business software application database.

2. The method of claim 1, wherein scanning the header portion further comprises identification information in one or more fields of the header portion, the one or more fields including a to field, a from field, a carbon copy field and a blind carbon copy field.

3. The method of claim 2, wherein the identification further comprises an e-mail address.

4. The method of claim 1, wherein adding the message further comprises adding the message and its attachments into the business software application database.

5. The method of claim 1 further comprising adding a new identification from the message and the message into the business software application database when no matching identification is located.

6. The method of claim 1 further comprising excluding a new identification from the message and the message from the business software application database when no matching identification is located.

7. The method of claim 6, wherein step of excluding a new identification is user selectable.

8. The method of claim 6, wherein excluding a new identification further comprises excluding a new identification from the business software application database when the new identification matches an excluded address pattern.

9. The method of claim 8, wherein the address pattern is user selectable.

10. A computer implemented mail management system for use with a business software application that has a database, the system comprising:
a mail management module that executes on a computer system, the mail management module further comprising instructions that scan a header portion of each message to locate an identification, instructions that compare the identification with a plurality of identifications stored in a business software application database to identify a matching identification, instructions that add the message with the matching identification into the business software application database wherein the message is associated with the matching identification, and instructions that create a Task associated with the message that is linked to the business software application database.

11. The system of claim 10, wherein the scanning instructions further comprises instructions that scan identification information in one or more fields of the header portion, the one or more fields including a to field, a from field, a carbon copy field and a blind carbon copy field.

12. The system of claim 11, wherein the identification further comprises an e-mail address.

13. The system of claim 10, wherein the instructions that add the message further comprises instructions that add the message and its attachments into the business software application database.

14. The system of claim 10, wherein the mail management module further comprises instructions that add a new identification from the message and the message into the business software application database when no matching identification is located.

15. The system of claim 10, wherein the mail management module further comprises instructions that exclude a new identification from the message and the message from the business software application database when no matching identification is located.

16. The system of claim 15, wherein the instructions that exclude a new identification further comprises instructions that permit the user to select the excluded new identifications.

17. The system of claim 15, wherein the instructions that exclude a new identification further comprises instructions that exclude a new identification from the business software application database when the new identification matches an excluded address pattern.

18. The system of claim 17, wherein the excluded address pattern is user selectable.

19. A computer implemented mail management system for use with a business software application that has a database, the system comprising:
a mail management module that executes on a computer system, the mail management module further comprising means for scanning a header portion of each message to locate an identification, means for comparing the identification with a plurality of identifications stored in a business software application database to identify a matching identification, means for adding the message with the matching identification into the business software application database wherein the message is associated with the matching identification, and means for creating a Task associated with the message that is linked to the business software application database.

20. The system of claim 19, wherein the scanning means further comprises means for scanning identification information in one or more fields of the header portion, the one or more fields including a to field, a from field, a carbon copy field and a blind carbon copy field.

21. The system of claim 20, wherein the identification further comprises an e-mail address.

22. The system of claim 19, wherein the adding means further comprises means for adding the message and its attachments into the business software application database.

23. The system of claim 19, wherein the mail management module further comprises means for adding a new identification from the message and the message into the business software application database when no matching identification is located.

24. The system of claim 19, wherein the mail management module further comprises means for excluding a new identification from the message and the message from the business software application database when no matching identification is located.

25. The system of claim 24, wherein the excluding means further comprises means for permitting the user to select the excluded new identifications.

26. The system of claim 24, wherein the excluding means further comprises means for excluding a new identification from the business software application database when the new identification matches an excluded address pattern.

27. The system of claim 26, wherein the excluded address pattern is user selectable.

28. A computer implemented mail management system for use with a business software application that has a database, the system being downloaded to a computer system from a piece of media, the piece of media further comprising:
instructions that scan a header portion of each message to locate an identification;
instructions that compare the identification with a plurality of identifications stored in a business software application database to identify a matching identification;
instructions that add the message with the matching identification into the business software application database wherein the message is associated with the matching identification; and
instructions that create a Task associated with the message that is linked to the business software application database.

29. The system of claim 28, wherein the scanning instructions further comprises instructions that scan identification information in one or more fields of the header portion, the one or more fields including a to field, a from field, a carbon copy field and a blind carbon copy field.

30. The system of claim 29, wherein the identification further comprises an e-mail address.

31. The system of claim 28, wherein the instructions that add the message further comprises instructions that add the message and its attachments into the business software application database.

32. The system of claim 28, wherein the mail management module further comprises instructions that add a new identification from the message and the message into the business software application database when no matching identification is located.

33. The system of claim 28, wherein the mail management module further comprises instructions that exclude a new identification from the message and the message from the business software application database when no matching identification is located.

34. The system of claim 33, wherein the instructions that exclude a new identification further comprises instructions that permit the user to select the excluded new identifications.

35. The system of claim 33, wherein the instructions that exclude a new identification further comprises instructions that exclude a new identification from the business software application database when the new identification matches an excluded address pattern.

36. The system of claim 35, wherein the excluded address pattern is user selectable.
